(19) United States
(12) Patent Application Publication
(10) Pub. No.: US 2023/0189858 A1
(43) Pub. Date: Jun. 22, 2023

(54) Method For Producing A Dried Food Pulp From A Fruit Or Vegetable, More Particularly For Producing Potato Flakes

(71) Applicant: ELEA SERVICE GMBH, Quakenbruck (DE)

(72) Inventors: James Paul Gratzek, Edina, MN (US); Kevin Hill, Osnabruck (DE); Robin Ostermeier, Osnabruck (DE); Stefan Toepfl, Osnabruck (DE)

(21) Appl. No.: 17/921,424

(22) PCT Filed: Jun. 10, 2021
(86) PCT No.: PCT/EP2021/065670

§ 371 Date: Oct. 26, 2022

(30) Foreign Application Priority Data
Jun. 10, 2020 (DE) 10 2020 207 293.0

(51) Int. Cl. A23L 19/15; A23L 5/30; A23L 29/212

(52) U.S. Cl. CPC A23L 19/15; A23L 5/30; A23L 29/212

(57) ABSTRACT

The present invention relates to a method for producing a dried food from a fruit or vegetable, more particularly for producing potato flakes. The invention proposes the following method steps for providing a dried food pulp from a fruit or vegetable, more particularly potato flakes, having a low free starch content without the addition of emulsifiers or other additives: Treating the fruit by applying an electrical field; comminuting the treated fruit or vegetable to form a food pulp; and drying the food pulp. The present invention also relates to a dried food pulp, more particularly potato flakes, produced according to the method of the invention, and the use of such a dried food pulp.

The present invention relates to a method for producing a dried food pulp from a fruit or vegetable, more particularly for producing potato flakes.

The present invention further relates to a dried food pulp, particularly potato flakes, as well as the use of such a dried food pulp.

Potato flakes are potatoes in flake form that have been cooked, processed into pulp and dried on drum dryers. To produce potato flakes, raw potatoes are washed, peeled and cut into slices. The slices are pre-cooked between 70° C. and 85° C. for 20 to 30 minutes, cooled to approx. 20° C. and then cooked to completion. The cooked potatoes are then comminuted into pulp, with consistency-improving ingredients added if necessary and finally dried on drum dryers and processed into flakes of desired size.

Potato flakes consist mainly of differently-sized aggregates of dried potato cells with a process-related proportion of broken potato cells of approx. 15 to 25%. The proportion of free gelatinized starch is dependent on the proportion of broken potato cells, which in turn significantly influences the consistency of the product prepared from potato flakes in addition to potato puree, other products can be produced from potato flakes, for example potato dumplings, croquettes or fried potato snacks.

Conventional processes for the production of potato flakes attempt to adjust the desired starch structure through crystallization and retrogradation of the starch during pre-cooking and subsequent cooling. The degree of gelatinization is largely determined by the temperature profile selected during pre-heating, and also by the moisture content, the pressure applied and the duration of pre-cooking. During comminution of the treated fruit or vegetable into a food pulp, the individual cells should be detached from the cell cluster and separated. The proportion of broken cells should be as low as possible so the proportion of free starch is as low as possible. A low proportion of starch is desired, as this is important, for example, for the production of stacked chips made from potato flakes or for the production of purees. A high proportion of free starch leads to gelatin-like structures with an undesirable stickiness, which is problematic for production and processing of the product.

In order to avoid and balance outa proportion of free starch that is too high, emulsifiers or other additives are used in the state of the art (Lamberti et al., “Starch transformation and structure development in production and reconstitution of potato flakes”, Lebensm.-Wiss. u.-Technol., Vol. 37, (2004), pages 417 to 427).

The object of the present invention is therefore to provide a method for the production of a dried food pulp from a fruit or vegetable, in particular for producing potato flakes, in which a low proportion of free starch can also be achieved without the addition of emulsifiers or other additives.

According to the invention, this objective technical problem is solved by a method for the production of a dried food pulp from a fruit or vegetable, in particular for producing potato flakes, which comprises the following steps:
Treating the fruit by applying an electric field;
comminuting the treated fruit or vegetable to form a food pulp; and
drying the food pulp.

Surprisingly, the present invention has shown that treatment through application of an electric field positively influences the structure of the treated fruit and vegetable so that the treated fruit and vegetable comprises a substantially lower proportion of structure-giving and water-binding polymers, particularly starch, during subsequent comminution. A problematic gelatin-like, sticky structure of the dried food pulp is thereby avoided.

Further surprising advantages of the method according to the invention are that the step of treatment of the fruit or vegetable through application of an electric field can shorten the overall processing time for production of the dried food pulp, which results in a higher throughput. The necessary energy requirements can also be significantly reduced by the present invention. This, among other reasons, is due to the fact that the food pulp can be dried faster and more gently. The gentler drying also avoids an undesired breaking of the cells and release of structure-giving and water-binding polymers, such as starch. Moreover, the step of treating the fruit or vegetable through application of an electric field also influences the characteristics of the structure-giving and water-binding polymers contained in the cells, such as the gelatinization characteristics of starch for example, in an advantageous manner. Surprisingly, the starch gelatinizes faster in the cells and at lower temperatures.

For the purposes of the present invention, a food pulp refers to a food that is processed into a pulpy mass with a viscous to semi-solid consistency, for example through mincing, pureeing, straining or grinding.

The invention can be further improved with the following further developments and advantageous configurations, each of which is advantageous in itself and can be combined with each other as desired.

The fruit and vegetable used for production of a dried food pulp is preferably a fruit and vegetable with a structure-giving and water-binding polymer, for example starch or pectin, which is released from the cell cluster into the solution during comminution and the associated separation of the cells. Such structure-giving and water-binding polymers, for example starch, are able to bind water and build up network effects, which, when released into the solution, lead to an undesirable increase of the viscosity and stickiness of the food pulp.

According to an embodiment, a pulsed electric field can be applied during treatment of the fruit or vegetable through application of an electric field. Preferably, a pulsed electric field that electroporates the cells of the fruit or vegetable can be applied. When such electroporation takes place, the semi-permeability of the cell membrane is removed. The removal of semi-permeability facilitates the introduction of water and other minerals into the cells of the fruit and vegetable. The semi-permeability, however, does not create pores large enough for the free starch to leave the cells. The starch therefore remains inside of the cells. The semi-permeability can be reversibly or irreversibly removed, wherein irreversible electroporation is preferred, as permanent removal of the semi-permeability offers more flexibility in the sequence of the further method steps. Reversible electroporation, which requires less energy than irreversible electroporation, may also be practicable.

During treatment of the fruit and vegetable through application of an electric field, an energy input of at least 0.1 kJ/kg can occur. The energy input can preferably be 0.3 to 5 kJ/kg. An energy input of this magnitude is well suited to carry out irreversible electroporation and to allow water and minerals to enter the cells, to influence the structure-giving and water-binding polymers, such as starch, within the cell and to improve, for example, the gelatinization properties of starch.

It has further surprisingly been shown that it is advantageous if an electric field of 0.1 kV/cm to 10 kV/cm, preferably of 0.5 kV/cm to 2 kV/cm, is applied. Such field strengths can be achieved with commercially available industrial capacitors and prevent undesirable thermal effects from occurring during treatment of the fruit or vegetable through application of an electric field, which lead to negative changes in the structure or composition of the fruit or vegetable.

In particular, the applied electric field can be a non-thermal electric field in which the upper energy limit is measured such that essentially no warming of the fruit or vegetable in the sense of Ohmic heating occurs during the step of treatment of the fruit or vegetable through-application of an electric field.

The electric field, particularly the electric pulse, can be generated through direct contact of a capacitor or its electrodes with the fruit or vegetable, as well as through conductive fluids, wherein the fruit or vegetable is wholly or partially submerged in the conductive fluid. Various electrode shapes can be used, for example plate, ring, grid, hollow or flow electrodes.

The pulse generator used to generate the electric field can preferably be a high-voltage pulse generator that generates electric fields in the form of short pulses in the micro to millisecond range of a high voltage in the kilovolt range. Marx generators can also be used as high-voltage pulse generators.

In terms of time and energy optimization, the fruit or vegetable can be treated with at least 10 electric pulses, preferably 100 to 200 electric pulses, and 30 to 50 electric pulses are particularly preferred.

According to another embodiment, the fruit or vegetable can be softened during treatment with a non-thermal electric field. Surprisingly, the softening of the fruit or vegetable has the advantageous effect that the individual cells can better compensate for the shear forces that occur during comminution of the fruit or vegetable into a food pulp, resulting in less cell breakdown. This avoids the release of structure-giving and water-binding polymers such as starch.

The method according to the invention is especially advantageous for fruits and vegetables with a structure-giving and water-binding polymer that release into the surrounding area during breakdown of the cells and which can lead to an undesirable gelatin-like sticky structure in the watery medium. Starchy fruits and vegetables in particular tend to have sticky structures when the proportion of broken down cells is too high.

According to an embodiment, the fruit or vegetable can be selected from the group consisting of a tuber vegetable, a root vegetable, a legume vegetable, a pore fruit, a stone fruit and a shell fruit.

According to a preferred embodiment, the fruit or vegetable can be selected from the group consisting of potatoes, sweet potatoes, pumpkin, parsnips, celery carrots, cabbage and chickpeas.

According to another embodiment, the fruit or vegetable can be cut before the step of comminution and after the step of treatment with an electric field. The treated fruit or vegetable can, for example, be cut into slices, strips or other pieces that increase the surface area and assist in the subsequent comminution or other further steps, where applicable, such as cooking or pre-cooking. Surprisingly, this has shown that the energy required for cutting after the step of treatment with an electric field significantly decreases and the cutting itself leads to less cell breakdown than in the case of non-treated fruit and vegetables.

Due to the improved gelatinization properties of the fruit and vegetable treated according to the invention, the step of cooling for retrogradation after pre-cooking can be omitted in one embodiment. This is energetically favorable, as the fruit and vegetable do not need to be cooled first and then reheated for cooking to completion.

According to another embodiment, the fruit or vegetable can be thermally treated, preferably cooked, before the comminution step. With such thermal treatment, for example cooking or boiling, the cell cluster is broken down and some degree of detaching and separation of the individual cells takes place before comminution during production of the food pulp.

According to another embodiment, the fruit or vegetable can be cooked without being precooked. With the method according to the invention, it is therefore possible to omit the otherwise conventional pre-cooking step as it is typically carried out, for example, in the production of potato flakes, as well as the subsequent cooling step for retrogradation of the crystallized starch. This leads to substantial energy savings and shortens the necessary processing time, thus surprisingly decreasing throughput, as fruits and vegetables that are either raw, in the sense of uncooked and unboiled, or have only been cooked and not pre-cooked can be comminuted into pulp.

According to another embodiment, the method according to the invention can be used to set a defined proportion of intact cells in the dried food pulp. This can be achieved, for example, in that the structure of the individual cells can be specifically influenced through the step of treating the fruit or vegetable with an electric field so that it is possible to avoid undesirable cell breakdown during the subsequent method steps of comminution into a food pulp and final drying, or to only break down a defined proportion of cells through the selection of suitable method parameters during treatment with an electric field, comminution and/or drying. In this way, it is possible to produce a dried food pulp that has desirable characteristics in terms of its stickiness, as the defined proportion of intact cells also allows the resulting proportion of released structure-giving and water-binding polymers, for example the proportion of free starch, to be regulated.

The invention according to the invention further relates to a dried food pulp, particularly potato flakes, which are produced by the method according to the invention.

The dried food pulp can distinguish itself—in comparison to untreated pulp onto which an electric field has not been applied—in that it has improved characteristics, for example a better product color, distribution of particle sizes and cell damage. These product characteristics depend on, among other things, the proportion of agglomerates and the proportion of reducing sugars. In an embodiment, the dried food pulp, particularly the potato flakes according to the invention, has over 85%, preferably over 90% and particularly preferably over 94% proportion of product with (1.) less than 20 particles with dark discoloration per 100 g of product and (2.) less than 15 particles with a particle size of more than 1.6 mm. With the present invention, it is therefore possible to obtain a dried food pulp of a particularly high quality, which brings considerable advantages with regard to product quality and possible applications of the products and thus the economy of production.

The invention also relates to the use of such a dried food pulp, particularly potato flakes, for the production of a puree, a snack food, for example chips or flips, a food dough, for example for dumplings or croquettes, a dried food product, for example mixes for dumplings, croquettes or soups, or a fried good, for example French fries.

The invention also relates to the use of a dried food pulp according to the present invention as a thickening agent or gelling agent.

In the following, the invention will be explained in more detail by means of advantageous embodiments with reference to the drawings and the following test examples. The presented advantageous further developments and embodiments are independent of one another and can be combined with each other in any way, as necessitated by the application of use.

Shown is:

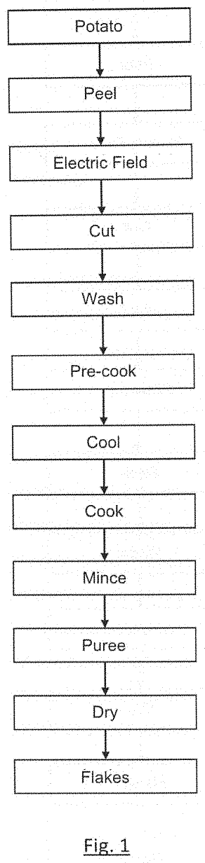

FIG. 1 a flowchart of a test setup for an illustrative method according to one embodiment of the present invention;

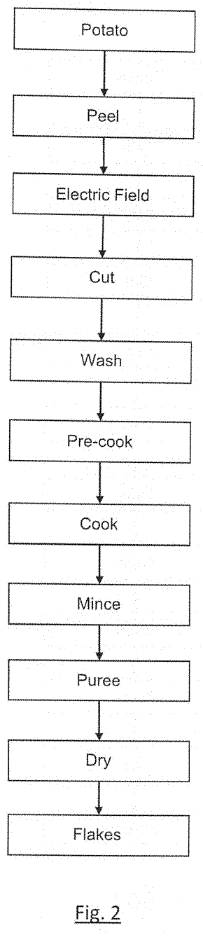

FIG. 2 a flowchart of an test setup for another illustrative method according to a further embodiment of the present invention; and

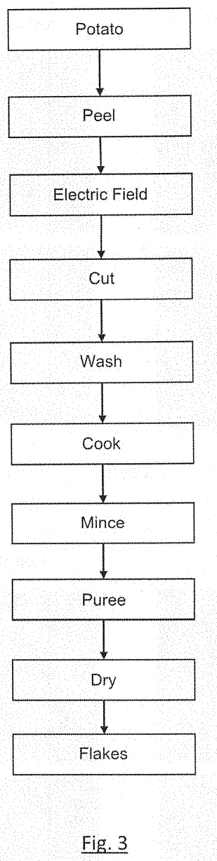

FIG. 3 a further flowchart of a test setup for another illustrative method according to yet another embodiment of the present invention;

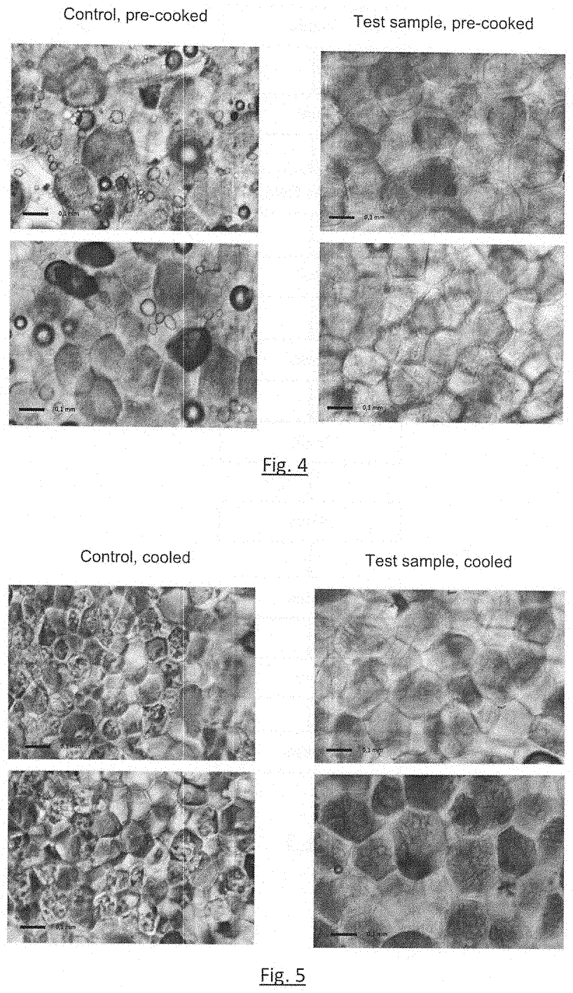

FIG. 4 microscopic images of a potato sample that is untreated as well as treated according to the invention after the pre-heating step;

FIG. 5 microscopic images of a potato sample that is untreated as well as treated according to the invention after the cooling step; and

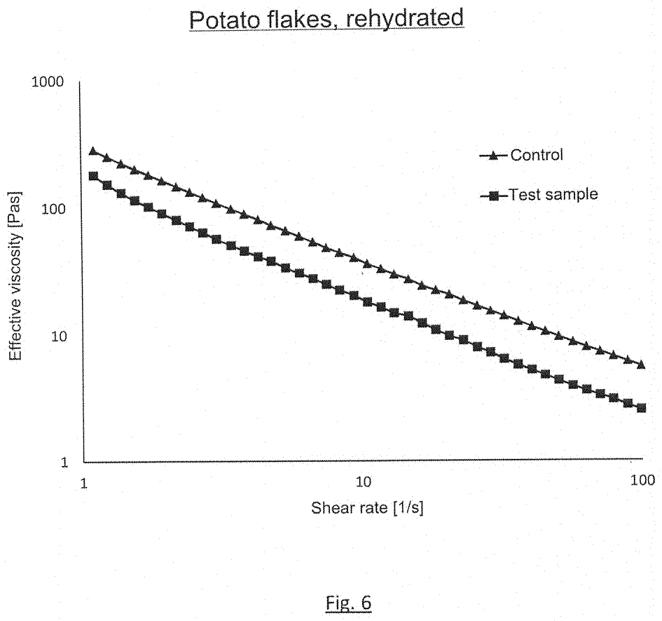

FIG. 6 a diagram representing the viscosity of rehydrated potato flakes that have been produced according to the method of the invention in comparison to conventionally produced rehydrated potato flakes.

In the following, an illustrative method for the production of a dried food pulp from a fruit or vegetable will be presented with reference to the flowchart of FIG. 1. The flowchart of FIG. 1 outlines the sequence of a method for the production of dried potato flakes.

The production of potato flakes includes a series of method steps with various functions. After peeling, the potatoes are cut into approx. 1 cm thick slices, followed by washing to remove free starch, pre-heating or pre-cooking for structural modification of the gelatinization, followed by cooling for retrogradation of the gelatinization and reaching a desired starch structure through crystallization (gelatinization) and retrogradation. This is followed by a boiling or cooking step to separate the cells, with subsequent comminution through mincing and pureeing, as well as the final drying and flake formation.

In the flowchart of FIG. 1 the step according to the invention of treatment of the fruit or vegetable through application of an electric field is provided.

In the embodiment shown, the step of treatment of the fruit or vegetable through application of an electric field before cutting specifically takes place after peeling the potatoes and before cutting the potatoes.

As will be explained in more detail in the test examples presented below, the fruit and vegetable is exposed to a pulsed electric field, which leads to electroporation and softening of the potato cells. This has an advantageous effect on cutting performance and the required energy input for cutting and final drying. Moreover, the proportion of free starch can surprisingly be significantly reduced, which enables drying on drum dryers with less stickiness and avoids an undesired gelatinous structure of high viscosity when rehydrating the potato flakes. This allows the flakes to be used in end products where a low proportion of free starch is desired. This, for example, is of interest in the production of stacked potato chips and advantageous in the production of puree. Moreover, the present invention improves the quality of food pulp, whereby the possible uses in end products is increased and production occurs more economically, as less waste from low-quality flakes is produced.

The treatment of the fruit or vegetable with an electric field has not only shown improvement in the quality of the end product, but also in the individual method steps. In the production of potato flakes, it has also been shown that the method according to the invention allows for a shortening of the pre-heating and cooling steps up to complete elimination (more details below) while still achieving a product quality with a low proportion of free starch during comminution and pureeing. This advantageously allows for the production of a dried food pulp with lower time and energy requirements than conventionally produced products that do not comprise a step of treatment of the fruit or vegetable through application of an electric field.

The lower proportion of free structure-giving and water-binding polymers, such as starch, in the solution, as well as cell opening through electroporation, additionally lead to faster and gentler drying. Additives such as emulsifiers, for example, can be avoided.

In the following, an illustrative test procedure according to the flowchart of FIG. 1 will be presented by means of a concrete test example. During treatment with an electric field, pulsed electric fields with an electric field strength in the range of 1 kV/cm are applied and an energy input in the range of 1 kJ/kg is carried out at a pulse count of 13 pulses. Subsequent to treatment with the pulsed electric field, cutting into approx. 1 cm thick slices takes place. After superficially adhering starch is removed in a washing step, pre-heating is carried out at 70° C. for 20 minutes, followed by cooling in a water bath at approx. 16° for 20 minutes. After cooling for retrogradation of the starch, cooking in steam at 100° C. for 35 minutes and comminution via a mincer with a hole size of 0.85 cm occurs. The minced potato pulp is pureed and mixed for 3 minutes with an immersion blender and finally dried on a drum dryer at 140° C. A small layer of the potato pulp is applied to the surface of the drum dryer and scraped off after 10 seconds of drying time.

Microscopy images of control samples, in which no treatment of the potatoes through application of an electric field according to the invention was carried out, were taken in comparison to potato samples treated according to the invention after the pre-cooking and cooling steps, which are shown in FIGS. 4 and 5, respectively.

FIG. 4 shows that the potatoes treated according to the invention are gelatinized more strongly, almost entirely throughout the cells, during pre-cooking and fewer ungelatinized starch granules, which are characterized by dark coloration, are present in contrast to the larger swollen gelatinized starch granules of the sample treated according to the invention.

The structure of the sample also differs significantly in the control sample after the cooling step (FIG. 5) in comparison to the sample treated according to the invention. While the sample treated according to the invention also shows gelatinized starch almost entirely throughout the individual cells after cooling, the untreated sample shows much smaller, less swollen gelatinized starch granules on the insides of the cells. This high degree of retrogradation in the untreated sample is problematic as this may result in a higher degree of undesirable starch breakdown during subsequent comminution. The starch in the cells treated according to the invention is already almost entirely gelatinized at this stage. This gelatinization and the pores created in the cell membrane as a result of electroporation mean that the shear forces occurring during comminution can be compensated for much better than both of the untreated cells. The retrograded starch granules can swell again in the untreated cells. In contrast to the samples produced according to the invention with their softened, porous structure, the intracellular pressure in the retrograded control sample cannot escape and rises within the cell, so that the shear forces can lead to a significant proportion of cell breakdown and release of free starch.

This result is also shown in FIG. 6, in which the viscosity of the rehydrated potato flakes according to the method of the invention is contrasted with the conventionally produced potato flakes.

To determine the viscosity, 5 grams of potato flakes are rehydrated in 36.5 grams of distilled water and the viscosity is subsequently determined according to DIN 53019 (AR 2000; TA instrument; Plate-Plate (ribbed) 1500 μm gap; measuring temperature 20° C.), where particles with a diameter larger than 1 mm are removed before measuring.

The produced potato flakes further undergo quality control based on the US Department of Agricuiture's guidelines A-A-20032G from Mar. 19, 2013, “Commercial Item Description Potatoes, white, dehydrated, point 6.2.2.5 Type II Mashed, Style B Flakes without peel”, which states the following: “Each individual sample unit of 100 g (3.5 oz) of product shall contain not more than 20 total pieces of peel, black, dark brown, or orange (scorched) specks and the average of all sample units shall not exceed 15 peel, black, dark brown or orange (scorched) specks measuring over 1.6 mm ( 1/16 in) in any dimension. Peel shall be classified as a defect”.

Specifically, 100 g of product is sieved by means of a sieve analysis with sieves 1.68 mm, 0.841 mm and 0.420 mm, Particles smaller than 0.420 mm are sorted out as a proportion of fines. Particles >0.420 and <1.6 mm are visually evaluated. Particles >1.6 mm are undesired agglomerates.

The examined potato flakes are then divided into groups in accordance with the guidelines described above:
Group A: (1.) less than 20 particles with brown, black or other discoloration and (2.) less than 15 particles >1.6 mm.
Group B: one of the two criteria for color variation or particle size is not met.
Group C: both criteria are not met.

These classifications are made on the basis of product characteristics such as color, particle size and cell breakdown, proportion of agglomerates and the proportion of free starch. The product color is mainly influenced by the content of reducing sugars in the raw ingredients or the extent of their leaching, as well as the thermal stress during production. Darker products are degraded in comparison to lighter products. A high proportion of cell breakdown and free starch also leads to increased stickiness and degradation of the product quality. After use of treatment of potatoes with an electric field, a significant shift in the quantity proportions of the various quality grades could be observed through sieve analysis and evaluation of product color in the subsequent production of dried flakes.

While a distribution of A: 84% , B: 11% and C: 5% was observed for the untreated sample, the distribution was surprisingly A: 95%, B: 3% and C: 2% after treatment according to the invention. This results in considerable advantages with regard to product quality and the possible applications of the products and thus the economic efficiency of production.

In the following, two further advantageous embodiments of a method according to the invention for the production of a dried food pulp, specifically potato flakes, will be presented with respect to FIGS. 2 and 3. Reference is made exclusively to the differences in the illustrative embodiment shown in FIG. 1.

In the method shown in the flow chart of FIG. 2, the method step of cooling is omitted. Surprisingly, the potato flakes produced according to the method shown in FIG. 2 have been found to have the same positive characteristics as the potatoes produced according to FIG. 1.

In the method shown in the flow chart of FIG. 3, the method steps of pre-cooking and cooling are omitted. Surprisingly, the potato flakes produced according to the method shown in FIG. 3 have been found have the same positive characteristics as the potatoes produced according to FIG. 1.

1. Method for the production of a dried food pulp from a fruit or vegetable, in particular for producing potato flakes, which comprises the following steps:
Treating the fruit or vegetable by applying an electric field;
comminuting the treated fruit or vegetable to form a food pulp; and
drying the food pulp.

2. Method according to claim 1, wherein an energy input of at least 0.1 kJ/kg, preferably from 0.3 to 5 kJ/kg occurs in the fruit or vegetable during treatment with an electric field.

3. Method according to claim 1, wherein an electric field from 0.1 kV/cm to 10 kV/cm, preferably from 0.5 kV/cm to 2 kV/cm is applied.

4. Method according to claim 1, wherein a pulsed electric field is applied during treatment, which electroporates the cells of the fruit or vegetable.

5. Method according to claim 4, wherein the fruit or vegetable is treated with at least 10 electric pulses, preferably 10 to 200 electric pulses, most preferably 30 to 50 electric pulses. cm 6. Method according to claim 1, wherein the fruit or vegetable is treated with a non-thermal electric field and thereby softened.

7. Method according to claim 1, wherein the fruit or vegetable is selected from the group comprising: a tuber vegetable, a root vegetable, a legume vegetable, a pome fruit, a stone fruit and a shell fruit.

8. Method according to claim 7, wherein the fruit or vegetable is selected from the group comprising: potatoes, sweet potatoes, pumpkin, parsnips, celery, carrots, cabbage and chickpeas.

9. Method according to claim 1, wherein the fruit or vegetable is cut before the comminution step and after the step of treatment with an electric field.

10. Method according to claim 1, wherein the fruit or vegetable is thermally treated, preferably cooked, before the comminution step.

11. Method according to claim 10, wherein the fruit or vegetable is cooked without being pre-cooked

12. Method according to claim 1, by which a defined proportion of intact cells in the dried food pulp is set.

13. Dried food pulp, particularly potato flakes, which is produced according to the method of claim 1.

14. Use of a dried food pulp according to claim 13 for the production of a puree, a snack food, a food dough, a dried food product or a fried food.

15. Use of a dried food pulp according to claim 13 as a thickening agent or as a gelling agent.

16. Method according to claim 2, wherein an electric field from 0.1 kV/cm to 10 kV/cm, preferably from 0.5 kV/cm to 2 kV/cm is applied.

17. Method according to claim 2, wherein a pulsed electric field is applied during treatment, which electroporates the cells of the fruit or vegetable.

18. Method according to claim 2, wherein the fruit or vegetable is treated with a non-thermal electric field and thereby softened.

19. Dried food pulp, particularly potato flakes, which is produced according to the method of claim 2.

20. Dried food pulp, particularly potato flakes, which is produced according to the method of claim 3.
